(19) United States
(12) Patent Application Publication
(10) Pub. No.: US 2012/0212815 A1
(43) Pub. Date: Aug. 23, 2012

(54) STEREOSCOPIC IMAGE DISPLAY DEVICE

(75) Inventors: Sin Young KIM, Daejeon (KR); Byoung Kun Jeon, Daejeon (KR); Moon Soo Park, Daejeon (KR)

(73) Assignee: LG CHEM, LTD., Seoul (KR)

(21) Appl. No.: 13/358,343

(22) Filed: Jan. 25, 2012

(30) Foreign Application Priority Data
Jan. 25, 2011 (KR) 10-2011-0007441
Jan. 25, 2012 (KR) 10-2012-0007314

(51) Int. Cl. G02B 27/26

(52) U.S. Cl. 359/465

(57) ABSTRACT

A stereoscopic image display device and a method for manufacturing a stereoscopic image display device are provided. A stereoscopic image display device that does not generate a crosstalk or a ghost phenomenon, can secure a wide viewing angle and realize excellent image qualities during displaying a 3D image may be provided.

### BACKGROUND

1. Field of the Invention

The present invention relates to a stereoscopic image display device and a method for manufacturing a stereoscopic image display device.

2. Discussion of Related Art

A stereoscopic image display device is a display device capable of delivering three-dimensional (3D) information to an observer.

Methods for displaying stereoscopic images may include, for example, methods that use glasses and methods that don't use glasses. Also, the methods using glasses may be classified into methods using polarizing glasses and methods using LC shutter glasses, and the methods that don't use glasses may be classified into stereoscopic/multi-view point binocular disparity methods, volumetric methods, holographic methods, and the like.

### SUMMARY OF THE INVENTION

The present invention provides a stereoscopic image display device and a method for manufacturing a stereoscopic image display device.

The present invention relates to a stereoscopic image display device that includes a display element including a region for generating an image light for a right eye, configured to generate the image light for the right eye and then transfer it toward an observer's side in a driving state and a region for generating an image light for a left eye, configured to generate the image light for the left eye and then transfer it toward the observer's side in a driving state; and a polarization control element that includes the polarization control regions for the right eye and for the left eye that are arranged so that the image light for the right eye transferred from the region for generating an image light for a right eye can enter into the polarization control region for the right eye and the image light for the left eye transferred from the region for generating the image light for the left eye can enter into the polarization control region for the left eye. The stereoscopic image display device may satisfy the following Formula 1.

A<B−(⅔)×c Formula 1

In Formula 1, “A” represents a length of the polarization control element, “B” represents a length of the display element, and “c” represents an interval between the polarization control element and the display element.

Unless particularly defined otherwise in this specification, numerical values of “A,” “B” and “c” applied to Formula 1 are values measured in units of “mm.”

Hereinafter, the stereoscopic image display device will be described in detail.

The term “driving state” of a stereoscopic image display device as used herein may refer to a state where the stereoscopic image display device is being driven, for example, the stereoscopic image display device is displaying a 3D image.

In this specification, terms such as vertical, horizontal, perpendicular or parallel used for defining angles may mean substantially vertical, horizontal, perpendicular or parallel, respectively, without causing damage to desired effects. For example, the terms may include errors in consideration of manufacturing errors or variations. Therefore, the terms may, for example, include an error of not more than approximately ±15 degrees, an error of not more than approximately ±10 degrees, or an error of not more than approximately ±5 degrees.

In this specification, the term “same” used for defining of a length, a width, a thickness or a pitch may mean substantially the same without causing damage to desired effects. For example, the term may include errors in consideration of manufacturing errors or variations. Therefore, the term “same” may, for example, include an error of not more than approximately ±60 μm, an error of not more than approximately ±40 μm, or an error of not more than approximately ±20 μm.

FIG. 1 is a schematic of an illustrative embodiment of a stereoscopic image display device 1. FIG. 1 shows a stereoscopic image display device viewed from the top of the stereoscopic image display device, more particularly a stereoscopic image display device observed in a direction from which an observer's head is viewed from the upper side of the stereoscopic image display device in a driving state.

As shown in FIG. 1, the illustrative stereoscopic image display device may include a light source 11, a polarizing plate 12, a display element 13, a polarizing plate 14 and a polarization control element 15. The display device shown in FIG. 1 may be a polarizing glasses type stereoscopic image display device in which lights from the light source 11 become an image light for the right eye and an image light for the left eye after passing through a region DR for generating the image light for the right eye and a region DL for generating the image light for the left eye of a display element 13, the image lights for the right eye and the left eye have polarization states different from each other after passing through the polarization control region PR for the right eye and the polarization control region PL for the left eye of a polarization control element 15, and then an observer wearing polarizing glasses may observe the image lights for the right eye and the left eye. However, a driving method of the stereoscopic image display device is not limited thereto.

The light source 11 may be, for example, arranged at the innermost side of the device 1 from the observer as shown in FIG. 1, and may emit un-polarized lights toward the polarizing plate 12 in a driving state. A conventional direct-type or edge-type backlight unit (BLU) used in the liquid crystal display device may be, for example, used as the light source 11. In addition, a variety of light sources may be used without limitation.

The polarizing plate 12 (hereinafter referred to as a “first polarizing plate”) arranged between the display element 13 and the light source 11 is an optical device including a transmission axis and an absorption axis perpendicular to the transmission axis. If lights emitted from the light source 11 enter into the polarizing plate 12, only the light having a polarization axis having a direction parallel to a direction of the transmission axis may pass through the polarizing plate 12.

In one embodiment, the display element 13 as shown in FIG. 1 may be a transmissive liquid crystal display panel formed by positioning a liquid crystal layer 132 between two substrates 131A and 131B. This type of the display panel may, for example, include a substrate 131A, a pixel electrode, an alignment layer, a liquid crystal layer 132, an alignment layer, a common electrode and a substrate 131B, which are sequentially arranged. As a driving element electrically connected to a transparent pixel electrode, an active drive circuit including a thin film transistor (TFT) and wires may be formed on the substrate 131A disposed at a side of the light source 11, as described above. For example, the pixel electrode may include indium tin oxide (ITO) and function as an electrode in each pixel. Also, the alignment layer may include, for example, a material such as a polyimide, and may align the liquid crystals. The liquid crystal layer 132 may include, for example, a liquid crystal in a vertical alignment (VA), twisted nematic (TN), super-twisted nematic (STN) or in-plane switching (IPS) mode. The liquid crystal layer 132 may pass lights from the light source 11 through each pixel or blocking the lights according to voltages applied from the drive circuit. For example, the common electrode may include ITO, and function as a common counter electrode.

In the liquid crystal layer 132, one or more pixel capable of generating image lights for the left eye or the right eye in a driving state may be formed. For example, the pixel may be a unit pixel including liquid crystal sealed between respective alignment layers. At least one unit pixel may form the regions DR and DL for generating the image lights for the right eye and the left eye. The regions DR and DL for generating the image lights may be arranged in row and/or column directions.

FIG. 2 shows a schematic of an illustrative arrangement of the regions DR and DL for generating the image lights. As shown in FIG. 2, the regions DR and DL for generating the image lights for the right eye and the left eye may have stripe shapes extending in the same direction, and may be alternately arranged adjacent to each other. Also, FIG. 3 shows a schematic of another illustrative arrangement of the regions DR and DL for generating the image lights. The regions DR and DL for generating the image lights for the right eye and the left eye may be alternately arranged adjacent to each other in a lattice pattern. However, the arrangement of the regions for generating the image lights in the stereoscopic image display device is not limited to the arrangements shown in FIGS. 2 and 3, and a variety of designs known in the art may be applicable.

The display panel may generate image signals including image lights for the right eye and the left eye by driving respective pixels according to signals, and then transfer the generated image signals toward an observer in a driving state.

Specifically, lights emitted from the light source 11 may pass through the first polarizing plate 12, and then may enter into the display element, and then lights after passing through the region DR for generating the image light for the right eye may become an image light for a right eye and lights after passing through the region DL for generating the image light for the left eye may become an image light for a left eye.

In FIG. 1, if the image lights for the right eye and the left eye are incident on the polarizing plate 14 (hereinafter referred to as a “second polarizing plate”) between the polarization control element 15 and the display element 13, lights having polarization axes parallel to the transmission axis of the polarizing plate 14 may pass through the polarizing plate 14.

In one embodiment, the first and second polarizing plates 12 and 14 may be arranged so that the transmission axes of the first and second polarizing plates 12 and 14 may form an angle of substantially 90 degrees.

The polarization control element may include a polarization control region PR for a right eye and a polarization control region PL for a left eye. The polarization control region PR for the right eye may be arranged so that the image light for the right eye generated and transferred from the region DR for generating an image light for a right eye of the display element may enter into the polarization control region PR for the right eye in a driving state, and the polarization control region PL for the left eye may be arranged so that the image light for the left eye generated and transferred from the region DL for generating the image light for the left eye of the display element may enter into the polarization control region PL for the left eye in a driving state.

Generally, when stereoscopic image display devices are constituted, polarization control regions for a right eye and for a left eye are formed to have exactly identical dimensions to and to correspond to corresponding regions for generating image lights for a right eye and for a left eye, and separate image lights for the right eye and the left eye. Therefore, the display element and the polarization control element have the same dimensions.

In the display device as described above, the polarization control element may be controlled so as to have different dimensions from those of the display element. Specifically, the display element and the polarization control element may satisfy the Formula 1 as described above. If dimensions of the display element and the polarization control element are controlled to satisfy the Formula 1, a crosstalk may be prevented, a viewing angle may become wider, and an observer may observe a 3D image with more excellent qualities.

In Formula 1, the “A” represents a length of the polarization control element. Specifically, the “A” may be a length of the polarization control element along a horizontal or vertical direction in case of being viewed by an observer observing a 3D image in a driving state of the stereoscopic image display device.

Also, the “B” in Formula 1 represents a length of the display element. Specifically, the “B” may be a length of the display element along a horizontal or vertical direction in case of being viewed by an observer observing a 3D image in a driving state of the stereoscopic image display device.

As above, each of the “A” and “B” may represent a length in a vertical or horizontal direction, however, when verifying the Formula 1, if one of the values is substituted for the length in the vertical direction, the other value is also used as the length in the vertical direction. On the other hand, if one of the values is substituted for the length in the horizontal direction, the other value is also used as the length in the horizontal direction. The above may be applied in the same manner as in the following Formulas 2 and 3.

Also, the “c” in Formula 1 represents a distance between the display element and the polarization control element in the stereoscopic image display device. For example, if the stereoscopic image display device includes a liquid crystal panel as the display element as shown in FIG. 1, the distance may be an interval between the surface of the liquid crystal layer in the display element and the surface of the polarization control element facing the liquid crystal layer. Also, if the display element includes a filter in which a black matrix is formed as will be described later, the “c” may be a distance between the liquid crystal layer and the polarization control element as described above, or a distance between the surface of the filter and the surface of the polarization control element facing the filter (for example, see FIG. 8).

FIG. 4 shows a schematic of an illustrative embodiment displaying only a display element 13 and a polarization control element 15 in the stereoscopic image display device as shown in FIG. 1. In FIG. 4, the “A,” “B” and “c” are marked in case of the stereoscopic image display device in FIG. 1. A direction observing the device in FIG. 4 is the same as in FIG. 1.

Also, in the stereoscopic image display device, a central line of the display element is preferably matched with a central line of the polarization control element. The term “central line” as used herein may refer to a line bisecting an element such as a display element, a polarization control element or a filter in a horizontal or vertical direction. In the above, the horizontal or vertical direction may be a direction defined based on an observer in a driving state of the stereoscopic image display device. Referring to FIG. 4, the central lines of the display element and the polarization control element are matched with each other along the line “Q” when viewed from the top.

If the display element and the polarization control element are configured to satisfy the Formula 1, the crosstalk in which an image light for a left eye enters into a polarization control region for a right eye or an image for a right eye enters into a LC region may be prevented, and a wide viewing angle and an excellent contrast ratio may also be secured, thereby maintaining high qualities of a 3D image.

In Formula 1, a specific value of the “B” is not particularly limited, but may be determined according to specifications of the stereoscopic image display device. For example, if the stereoscopic image display device is a 10 inches device, the “B” may be approximately 135 mm. If the stereoscopic image display device is a 47 inches device, the “B” may be approximately 590 mm or in a range of approximately 587.7 mm to 588.1 mm. If the stereoscopic image display device is a 72 inches device, the “B” may be in a range of approximately 850 mm to 900 mm. As such, the “B” may be widely varied according to the specifications of the stereoscopic image display device. However, the “B” may be in a range from approximately 100 mm to 1,500 mm considering conventional specifications of devices currently known in the art, but it is not limited thereto.

Also, a specific range of the “c” is determined according to the specifications of the stereoscopic image display device. For example, if the stereoscopic image display device is a 47 inches device, the “c” may be approximately 1.1 mm. The “c” may be in a range of approximately 0.5 mm to 1.5 mm considering conventional specifications of devices currently known in the art.

In the stereoscopic image display device, the display element and the polarization control element may be arranged so as to satisfy the Formula 1, and may be arranged so as for the image light for the right eye transferred from the display element to enter into the polarization control region for the right eye of the polarization control element in a driving state and for the image light for the left eye transferred from the display element to enter into the polarization control region for the left eye of the polarization control element in a driving state. For example, if the regions DR and DL for generating the image lights for the right eye and for the left eye of the display element have the stripe shapes as shown in FIG. 2, the polarization control regions PR and PL of the polarization control element may have corresponding stripe shapes as shown in FIG. 5. Also, if the regions DR and DL for generating the image lights for the right eye and for the left eye of the display are arranged in a lattice pattern as shown in FIG. 3, the polarization control regions PR and PL for the right eye and for the left eye of the polarization control element may be arranged in a corresponding lattice pattern as shown in FIG. 6.

In one embodiment, the regions for generating the image lights of the display element and the polarization control regions of the polarization control element may be arranged so as to satisfy the following Formula 2.

E×(1×(2c)/(3B))=F Formula 2

In Formula 2, E represents a distance from the central line of the display element to the region for generating the image light for the right eye or for the left eye, F represents a distance from the central line of the polarization control element to the polarization control region for the right eye or for the left eye corresponding to the region for generating the image light for the right eye or for the left eye forming the distance E, and B and c are the same as defined above in Formula 1.

Unless particularly defined otherwise, values of the “E,” “B,” “F” and “c” applied to Formula 2 are values measured in units of “mm.”

The “E×(1−(2c)/(3B))”and “F” may have the same values. In this case, the term “same” may means substantially the same considering the manufacturing error, and the like, as described above.

If the relationship between the regions for generating the image lights and the polarization control regions is controlled so as to satisfy the above-described relationship, effects improving the qualities of the stereoscopic image display device including the prevention of the crosstalk and securing the wide viewing angles may be maximized.

In the above, the central line may refer to a line bisecting each element in a horizontal or vertical direction, as previously described above.

As above, the “E” is a distance from the central line to the region for generating the image light for the right eye or for the left eye of the display element, and, specifically, a distance in the horizontal or vertical direction based on an observer observing a 3D image in a driving state. Also, the “E” may be a distance from the central line to a site from which the region for generating the image light for the right eye or for the left eye begins.

For example, referring to FIG. 7, the distance from the central line, which is positioned on the line “Q,” to the region DL for generating the image light for the left eye that comes first on the right side is marked as the “EL1,” and the distance from the central line to the region DL for generating the image light for the left eye that comes second is marked as the “EL2.” Also, the distance from the central line to the region DR for generating the image light for the right eye that comes first on the right side is zero, and the distance from the central line to the region DR for generating the image light for the right eye that comes second is marked as the “ER2.”

As above, the “F” represents a distance from the central line of the polarization control element to the polarization control region for the right eye or for the left eye corresponding to the region for generating the image light for the right eye or for the left eye forming the distance “E,” and, more specifically, the distance in the horizontal or vertical direction based on an observer who observes a 3D image in a driving state. Also, the “F” may be a distance from the central line to a site from which a corresponding polarization control region begins. As such, the term “polarization control region for a right eye or for a left eye corresponding to the region for generating the image light for the right eye or for the left eye forming the distance E” may refer to a polarization control region for a right eye or for a left eye arranged in a position into which the region for generating the image light for the right eye or for the left eye forming the distance E may enter.

For example, referring to FIG. 7, the distance from the central line, which is positioned on the line “Q,” to the polarization control region PL for the left eye corresponding to the region DL for generating the image light for the left eye that comes first on the right side and forms the distance EL1 is marked as the “FL1,” and the distance from the central line to the polarization control region PL for the left eye corresponding to the region for generating the image light for the left eye that comes second and forms the distance EL2 is marked as the “FL2.” Also, the distance from the central line to the polarization control region for the right eye corresponding to the region DR for generating the image light for the right eye that comes first on the right side is zero, and the distance from the central line to the polarization control region for the right eye corresponding to the region DR for generating the image light for the right eye that comes second and forms the distance EL2 is marked as the “FR2.”

Although the distance of the regions arranged on the right side of the central line has been described, such a distance may also be applied to the regions arranged on the left side of the central line.

According to such arrangement, the image lights for the right eye and the left eye generated from the display element may be transmitted to an observer via the exactly corresponding polarization control region of the polarization control element.

In the display device, the image light for the right eye after passing through the polarization control region for the right eye of the polarization control element may have a different polarization state from the image light for the left eye after passing through the polarization control region for the left eye of the polarization control element.

In one embodiment, the image light for the right eye after passing through the polarization control region for the right eye and the image light for the left eye after passing through the polarization control region for the left eye may be linearly polarized lights having polarization axes that are substantially perpendicular to each other, or be circularly polarized lights of which rotating directions are different from each other, for example, be left-circularly polarized light and right-circularly polarized light.

In case where the image lights after passing through the polarization control regions is linearly polarized lights having polarization axes perpendicular to each other, one of the polarization control regions for the right eye and for the left eye may be a region configured not to rotate polarization axes of lights passing through it, and the other region may be a region configured to rotate polarization axes of lights passing through it so as to be perpendicular to the polarization axes of the lights after passing through the region configured not to rotate the polarization axes. Therefore, the polarization axes of lights after passing through the polarization control regions for the right eye and for the left eye may become vertical to each other. In this case, the polarization control element may include a λ/2 wavelength layer arranged on only one of the polarization control regions for the right eye and for the left eye. In this case, a space in which the λ/2 wavelength layer is not positioned may include, for example, a transparent glass or resin, or may be, for example, vacant.

In the above, in case where image lights after passing through the polarization control regions is circularly polarized lights of which rotating directions are different from each other, one of the polarization control regions for the right eye and for the left eye may be a region configured to convert lights passing through it into left-circularly polarized light, and the other region may be a region configured to convert lights passing through it into right-circularly polarized light. As a result, the lights after passing through the polarization control region for the right eye or for the left eye may have different polarized states. In this case, the polarization control element may include a λ/2 wavelength layer arranged on only one of the polarization control regions for the right eye and for the left eye and λ/4 wavelength layers arranged on both of the polarization control regions for the right eye and for the left eye.

In another embodiment, the polarization control element may include a λ/4 wavelength layer arranged on both of the polarization control regions for the right eye and for the left eye. In the above, the optical axes of the λ/4 wavelength layer on the polarization control region for the right eye may have a direction different from the λ/4 wavelength layer on the polarization control region for the left eye. The term “optical axis” as used herein may refer to a fast axis or slow axis with respect to light passing through a corresponding region. If the wavelength layer has the optical axes formed in different directions as described above, for example, the optical axis of the polarization control region for the left eye may be formed to be vertical to the optical axis of the polarization control region for the right eye.

A variety of materials and methods for constituting such a polarization control element are known in the art. Such materials and/or methods may be applied.

In one embodiment, the display element may further include a filter having a black matrix formed therein. In this case, the black matrix may be formed at the boundary between the regions for generating the image lights for the right eye and for the left eye of the display element.

For example, the filter may be a conventional color filter. The color filter may include a black matrix and a color filter section arranged to separate lights from a light source into the three primary colors, for example, red, green and blue (RGB). As such, the black matrix may have a function shielding light.

FIG. 8 shows a schematic of an illustrative embodiment of the display device, that is, the display device as shown in FIG. 1, in which a filter 81 is arranged between a liquid crystal layer 132 and a substrate 131B. Here, the filter 81 includes a color filter section 811 and a black matrix 812. A direction observing the stereoscopic image display device as shown in FIG. 8 is the same as in FIG. 1.

Such a stereoscopic image display device may satisfy the Formula 3.

A>B−(½)×BM Formula 3

In Formula 3, A and B are the same as defined in the Formula 1 above, and BM is a length of the black matrix.

Unless particularly defined otherwise, values of the “A” and “B” applied to Formula 3 are values measured in units of “mm” and a value of the “BM” is a value measured in units of “μm.”

In Formula 3, the “BM” is a length of the black matrix, and, specifically, a length in the horizontal or vertical direction based on an observer observing a 3D image in a driving state of the stereoscopic image display device. The length of the black matrix may be varied according to the configuration of the display device, and the lengths of the black matrices in the same display device may be different from each other. The “BM” may be a length of any black matrix included in the stereoscopic image display device, and preferably, a length of a black matrix arranged at the boundary between the regions for generating the image lights for the right eye and for the left eye.

The length of the black matrix may be varied according to the specific specifications of a display device. For example, in the case of a 47-inch display device, the “BM” may be in a range from approximately 200 μm to 300 μm. The “BM” may be in a range from approximately 50 μm to 400 μm considering the specifications of conventional display devices currently known in the art.

If the stereoscopic image display device satisfies the relationship of Formula 3, it is possible to realize an image with more excellent qualities.

Although the major elements of the stereoscopic image display device have been described, the display device may further include various elements used in the stereoscopic image display device, such as polarized glasses, in addition to the above-described elements. In this case, specific embodiments of the respective elements are not particularly limited.

Also, the present invention relate to a method for manufacturing a stereoscopic image display device. The method may includes placing a display element including a region for generating the image light for the right eye configured to generate an image light for a right eye and a region for generating the image light for the left eye configured to generate an image light for a left eye; and a polarization control element including a polarization control region for a right eye and a LC region. The display element and the polarization control element may satisfy the Formula 1. Also, the placement of the display element and the polarization control element may be performed so as for the image light for the right eye transferred from the display element to enter into the polarization control region for the right eye in a driving state, and for the image light for the left eye transferred from the display element to enter into the polarization control region for the left eye in a driving state.

The method for manufacturing a stereoscopic image display device may be a method for manufacturing the stereoscopic image display device as described above. Therefore, the method may be performed using the same types of the display element and the polarization control element as described above. Specific embodiments of the method for manufacturing a stereoscopic image display device are not particularly limited, but the method may be carried out without limitation as long as the display element and the polarization control element satisfying the Formula 1 are used in the stereoscopic image display device. For example, the method may be performed by including placing the display element and the polarization control element in an appropriate housing according to conventional methods.

In the method, placing the display element and the polarization control element so as for the image light for the right eye transferred from the display element to enter into the polarization control region for the right eye in a driving state, and for the image light for the left eye transferred from the display element to enter into the polarization control region for the left eye in a driving state may be preferably performed so as to satisfy the above-described Formula 2.

In the method, the display element including the filter having the black matrix formed therein may also be used as the display element. In this case, the respective elements may satisfy the Formula 3.

In addition to the above, other elements of the method for manufacturing a stereoscopic image display device are not particularly limited, but may be properly selected to perform the method as long as the contents known in the art do not cause damage to the effects of the present invention.

### BRIEF DESCRIPTION OF THE DRAWINGS

FIG. 1 shows a schematic of an illustrative embodiment of a stereoscopic image display device.

FIGS. 2 and 3 show schematics of illustrative embodiments of the arrangements of regions for generating image lights for a right eye or for a left eye.

FIGS. 4, 7 and 8 show schematics of illustrative embodiments for explaining the relationship of the dimensions of elements.

FIGS. 5 and 6 show schematics of illustrative embodiments of the arrangements of polarization control regions for a right eye and for a left eye.

FIGS. 9 and 10 shows the evaluation results of crosstalk characteristics of stereoscopic image display devices manufactured in Examples and Comparative Examples.

### EXPLANATIONS OF THE MARKS IN THE FIGS

1: a stereoscopic image display device

11: a light source

12, 14: polarizing plates

13: a display element

131A, 131B: substrates

132: a liquid crystal layer

15: a polarization control element

DR: a region for generating an image light for a right eye

DL: a region for generating an image light for a left eye

B: a length of a display element

A: a length of a polarization control element

c: a distance from a display element to a polarization control element

Q: a position on which a central line is positioned

EL1, EL2: distances from a central line to regions for generating an image light for a left eye

ER2: a distance from a central line to a region for generating an image light for a right eye

FL1, FL2: distances from a central line to polarization control regions for a left eye

FR2: a distance from a central line to a polarization control region for a right eye

BM: a length of a black matrix

81: a filter

811: a color filter section

812: a black matrix

### DETAILED DESCRIPTION OF EXEMPLARY EMBODIMENTS

Hereinafter, the stereoscopic image display device will be described in further detail with reference to Examples and Comparative Examples. However, the following Examples are not intended to limit the scope of the stereoscopic image display device.

### EXAMPLE 1

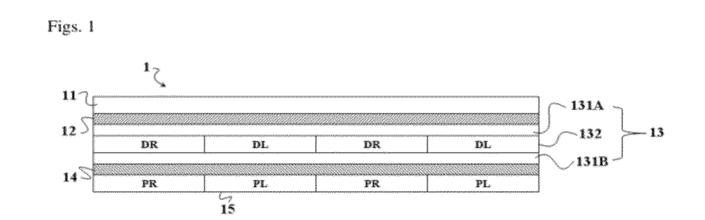

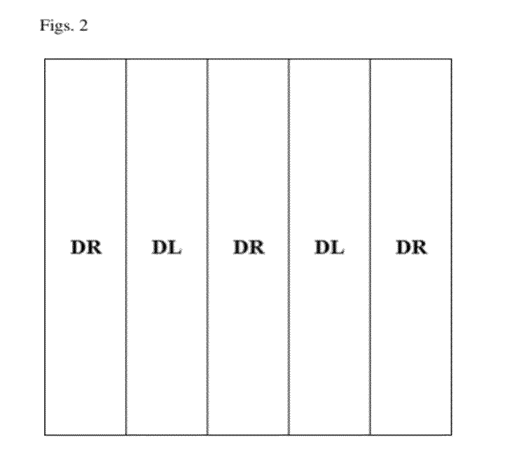

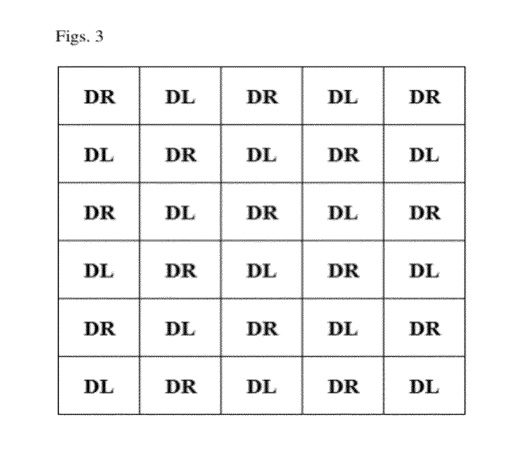

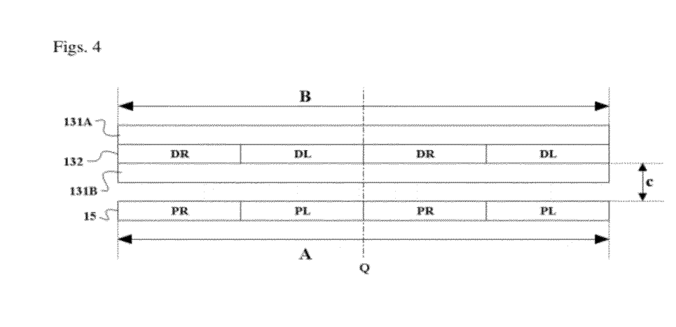

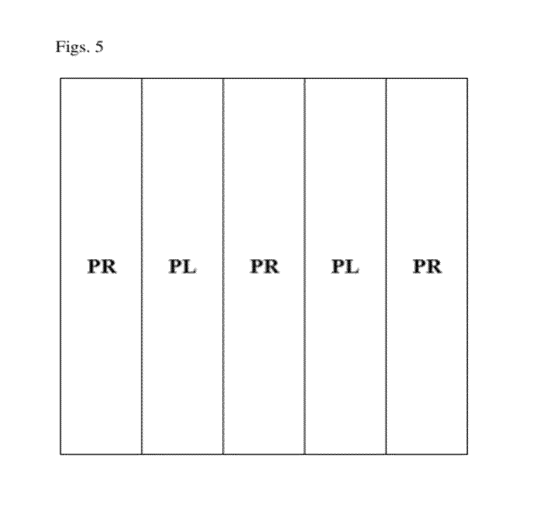

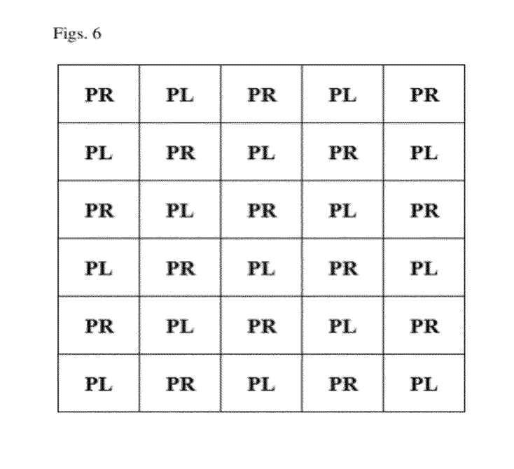

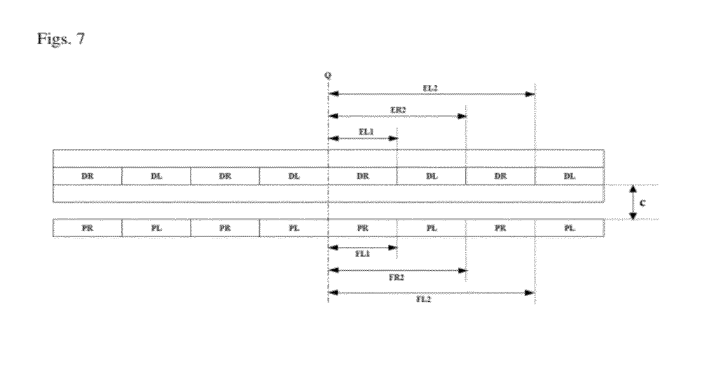

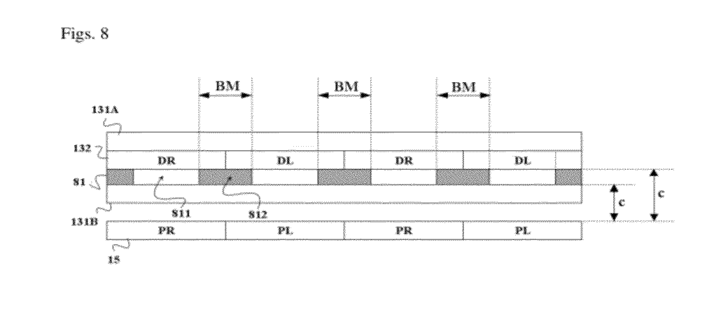

Evaluation was performed using a 47-inch stereoscopic image display device 1 having a configuration as shown in FIG. 1. Specifically, as the display element 13, a transmissive liquid crystal panel including the regions for generating the image lights for the right eye and for the left eye arranged as shown in FIG. 2, and black matrices arranged on the boundaries of the regions for generating the image lights for the right eye and for the left eye as shown in FIG. 8 was used. Also, as the polarization control element 15, an element including the polarization control regions for the right eye and for the left eye in which a λ/4 wavelength layer was arranged and in which the arrangement was as in FIG. 5 was used. In the above, the λ/4 wavelength layers formed in the polarization control regions for the right eye and for the left eye respectively were positioned so as for the optical axes (slow axes) thereof to be different from each other and to form 90 degrees, and for a line bisecting an angle formed by the optical axes to be vertical to the absorption axis of the polarizing plate 14. Also, the placement was performed so that the central lines of the display element and the polarization control element could match each other. In the configuration of the display device, a 47-inch liquid crystal panel having a longitudinal length (B) of 590 mm and including a color filter having a black matrix having a longitudinal length (BM) of 240 μm was used as the display element 13, and arranged so that the distance “c” between the liquid crystal panel and the polarization control element 15 could be 1.2 mm. In the above, the display device was constituted so as to satisfy the Formula 1 by using a polarization control element having a length “A” of 589 mm as the polarization control element 15.

### COMPARATIVE EXAMPLE 1

A display device was configured in the same manner as in Example 1, except that a polarization control element having the same dimensions as the display element was used as the polarization control element, and therefore a stereoscopic image display device 1 which did not satisfy the Formula 1 was used to evaluate crosstalk characteristics.

### EXPERIMENTAL EXAMPLE 1

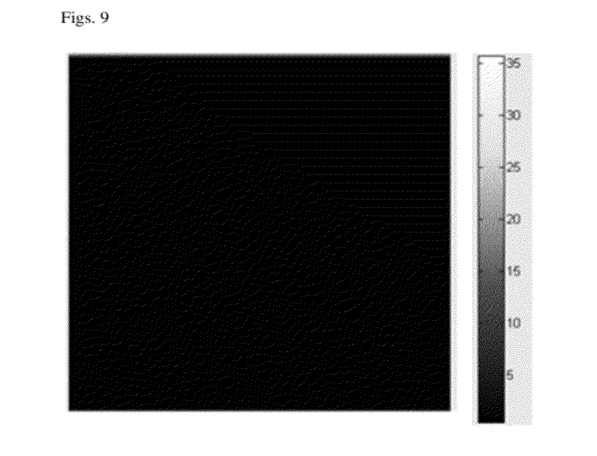

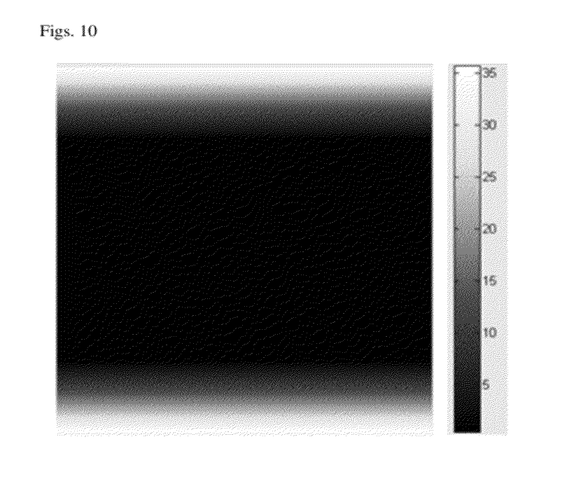

Crosstalk characteristics of the respective display devices in Example and Comparative Example were evaluated using an evaluation program prepared by MatLab. The results are shown in FIGS. 9 and 10, respectively. As such, the crosstalk characteristics could be defined by the following Equation A. A region indicated in black in FIGS. 9 and 10 refers to a region of a screen in which crosstalk did not take place, and a region indicated in a bright color refers to a region in which crosstalk took place. FIG. 9 shows the results for the display device of Example 1, and FIG. 10 shows the results for the display device of Comparative Example 1. As shown in FIGS. 9 and 10, it was confirmed that a large amount of crosstalk took place at upper and lower portions of the screen in the case of the display device of

### COMPARATIVE EXAMPLE 1

Equation A

Crosstalk characteristic (Unit: cd/m²)=Brightness of an image light for a left eye penetrating a right eye or brightness of an image light for a right eye penetrating a left eye while observing a 3D image

A stereoscopic image display device that does not generate a crosstalk or a ghost phenomenon, can secure a wide viewing angle and realize excellent image qualities during displaying a 3D image may be provided.

What is claimed is:

1. A stereoscopic image display device comprising:
a display element comprising a region for generating an image for a right eye, configured to generate the image for the right eye and then transfer it toward an observer's side in a driving state and a region for generating an image for a left eye, configured to generate the image for the left eye and then transfer it toward the observer's side in a driving state; and
a polarization control element comprising polarization control regions for the right eye and the left eye arranged so as for the images for the right eye and the left eye transferred from the display element to be incident to the polarization control regions for the right eye and the left eye, respectively,
wherein the stereoscopic image display device satisfies the following Formula 1:
A<B−(⅔)×c Formula 1
wherein A represents a length of the polarization control element, B represents a length of the display element, and c represents an interval between the polarization control element and the display element.

2. The stereoscopic image display device of claim 1, wherein B is in a range of 100 mm to 1,500 mm.

3. The stereoscopic image display device of claim 1, wherein c is in a range of 0.5 mm to 1.5 mm.

4. The stereoscopic image display device of claim 1, satisfying the following Formula 2:
E×(1×(2c)/(3B))=F Formula 2
wherein E represents a distance from a center of the display element to the region for generating the image for the right eye or the left eye, F represents a distance from a center of the polarization control element to the polarization control region for the right eye or the left eye, corresponding to the region for generating the image for the right eye or the left eye having the distance E, and B and c are the same as defined in the Formula 1 of claim 1.

5. The stereoscopic image display device of claim 1, wherein the image for the right eye after passing through the polarization control region for the right eye has a polarization axis vertical to the image for the left eye after passing through the polarization control region for the left eye.

6. The stereoscopic image display device of claim 5, wherein the polarization control element comprises a λ/2 wavelength layer arranged on one of the polarization control region for the right eye and the polarization control region for the left eye.

7. The stereoscopic image display device of claim 1, wherein the image for the right eye after passing through the polarization control region for the right eye and the image for the left eye after passing through the polarization control region for the left eye are circularly polarized lights of which rotating directions are different from each other.

8. The stereoscopic image display device of claim 7, wherein the polarization control element comprises a λ/2 wavelength layer arranged on only one of the polarization control region for the right eye and the polarization control region for the left eye; and a λ/4 wavelength layer arranged on both of the polarization control regions for the right eye and the left eye.

9. The stereoscopic image display device of claim 7, wherein the polarization control element comprises a λ/4 wavelength layer arranged on the polarization control regions for the right eye and the left eye, and the optical axis of the λ/4 wavelength layer on the polarization control region for the right eye is different from that of the λ/4 wavelength layer on the polarization control region for the left eye.

10. The stereoscopic image display device of claim 1, wherein the display element further comprises a filter in which a black matrix is formed.

11. The stereoscopic image display device of claim 10, wherein the black matrix is formed at the boundary between the regions for generating the images for the right eye and the left eye of the display element.

12. The stereoscopic image display device of claim 10, satisfying the following Formula 3:
A>B−(½)×BM Formula 3
wherein A and B are the same as described in Formula 1, and BM represents a length of the black matrix.

13. The stereoscopic image display device of claim 12, wherein BM is in a range of 50 μm to 400 μm.

14. A method of manufacturing a stereoscopic image display device, comprising placing a display element comprising a region for generating an image for a right eye, configured to generate the image for the right eye and a region for generating an image for a left eye, configured to generate the image for the left eye; and a polarization control element comprising polarization control regions for the right eye and the left eye,
wherein the display element and the polarization control element satisfy the following Formula 1, and wherein the placing is performed so as for the image for the right eye transferred from the display element to be incident to the polarization control region for the right eye in a driving state and for the image for the left eye transferred from the display element to be incident to the polarization control region for the left eye:
A<B−(⅔)×c Formula 1
wherein A represents a length of the polarization control element, B represents a length of the display element, and c represents an interval between the polarization control element and the display element.

15. The method of claim 14, wherein, during the placing of the display element and the polarization control element, they are placed so as to satisfy the following Formula 2:
E×(1×(2c)/(3B))=F Formula 2
wherein E represents a distance from a center of the display element to the region for generating the image for the right eye or the left eye, F represents a distance from a center of the polarization control element to the polarization control region for the right eye or the left eye, corresponding to the region for generating the image for the right eye or the left eye having the distance E, and B and c are the same as defined in the Formula 1 of claim 14.

16. The method of claim 14, wherein the display element comprises a filter in which a black matrix is formed.

17. The method of claim 16, wherein the display element, the polarization control element and the black matrix satisfy the following Formula 3:
A>B−(½)×BM Formula 3
wherein A and B are the same as described in Formula 14, and BM represents a length of the black matrix.
